(19) United States
(12) Patent Application Publication
(10) Pub. No.: US 2026/0156105 A1
(43) Pub. Date: Jun. 4, 2026

(54) SYSTEM AND METHOD FOR MULTI-WAY AUTHORIZATION OR AUTHENTICATION OF NETWORK FUNCTION SERVICES IN COMMUNICATION NETWORKS

(71) Applicant: Huawei Technologies Co., Ltd., Shenzhen (CN)

(72) Inventors: Bidi Ying, Ottawa (CA); Hang Zhang, Ottawa (CA)

(21) Appl. No.: 19/454,754

(22) Filed: Jan. 21, 2026

Related U.S. Application Data
(63) Continuation of application No. PCT/CN2023/109016, filed on Jul. 25, 2023.

(51) Int. Cl. H04L 9/40

(52) U.S. Cl. CPC H04L 63/08; H04L 63/10

(57) ABSTRACT

Systems and methods for network function (NF) service authentication in a network are provided. An example method includes: receiving, by a gateway (GW) of the network, from an NF service consumer, a service request for at least one NF service; generating, by the GW, a temporary identifier (ID) of the NF service consumer, a temporary ID of an NF service producer of the network, and a first proof for use by the NF service producer to authenticate the NF service consumer; sending, by the GW, an access request to the NF service producer, the access request including at least one of: the first proof, the temporary ID of the NF service consumer, or the temporary ID of the NF service producer; receiving, by the NF service producer, the access request; and validating, by the NF service producer, the first proof.

### CROSS-REFERENCE TO RELATED APPLICATIONS

This application is a continuation of International Application No. PCT/CN2023/109016, filed on Jul. 25, 2023, the disclosure of which is hereby incorporated by reference in its entirety.

### TECHNICAL FIELD

The present disclosure generally pertains to authorization or authentication in communication networks and, in particular, to a system and a method for (e.g., multi-way) authorization or authentication of network function services.

### BACKGROUND

As a next-generation mobile communications system, the sixth-generation (6G) is expected to go far beyond providing communication pipelines or connectivity to intelligence. 6G may support computing and processing capabilities of different network function (NF) services in a distributed and collaborated manner. These NF services may include one or multiple data communication, data processing, or data computing functionalities, or various vertical applications (e.g., vehicle-to-everything (V2X), internet of things (IoT)). These NF services may be network-native services, provided by a network provider, or plug-in service provided by third parties. These providers may be denoted as NF service producers. In some current implementations, for example as in the previous fifth-generation (5G) network, a special NF service providing connectivity is provided. To support these NF services, 6G may schedule or coordinate network-based computing and processing capabilities. These capabilities may be provided by entities or infrastructures (e.g., modules to provide computing resources and management of computing procedures).

The third generation partnership project (3GPP) establishes an access control security system. The access control security system provides an authorization process that may grant a NF service consumer access to NF service producers. However, authorization for a NF service consumer may not be efficient because of the extension of 6G to multiple NF services (e.g., network-native or plug-in services provided by third-parties). Besides, the access control security system supports both server-side and client-side certificates. Transport layer security (TLS) client and server certificates are required by 3GPP to be compliant with the Service Based Architecture (SBA) certificate profile for authentication, for example, all NF service consumers and network repository functions (NRF) are required to support mutually authenticated TLS and Hypertext Transfer Protocol Secure (HTTPS). The identities in the end entity certificates according to 3GPP are used for authentication and policy checks. The NF service consumers and the NRF in 3GPP support both server-side and client-side certificates. The NRF ensures that the NF Service Consumer is authorized to discover the NF Service Producer service(s). If the NF Service Consumer is authorized to receive the service requested, the NF Service Producer shall grant the NF Service Consumer access to the service API.

However, the current authorization for a NF service lacks mutual validation between NF service consumer and NF service producer in 6G. That is, while a NF service customer is validated, the NF service producer is not, and this may become a security issue in future network scenarios. In 6G, a NF service consumer and a NF service producer may be deployed by different providers, and they may not necessarily trust each other. Mutual authentication may thus be required among them before a permission to access a NF service producer is granted. In some cases, NF service producers may require validation before providing NF services to the NF service consumer. The current authorization for a NF service also lacks ID privacy protection and authorization information protection. NF service consumers and a NRF require the use of both server-side and client-side certificates. These certificates may leak real ID of NF service consumer, compromising ID privacy. This may be undesirable for example if a NF service producer does not want to disclose the NF service producer identity to a NF service consumer, or if a NF service consumer wants to avoid disclosing the NF service consumer identity to a NF service producer. The NF service consumer's location and the NF service producer's location may also be a part of sensitive information which may not be sufficiently protected under present schemes. Current implementations of a static authorization, based on a local authorization policy at the NRF and the NF Service in service based interface (SBI) architecture, lack mutual validation between the NF service consumer and the NF service producer, and privacy protection.

Therefore, improvements in authorization of network function services in communication networks are desirable.

This background information is provided to reveal information believed by the applicant to be of possible relevance to the present application. No admission is necessarily intended, nor should be construed, that any of the preceding information constitutes prior art against the present application.

### SUMMARY

Embodiments of this disclosure provide for systems and methods of authorization, authentication, or both, for NF services. The authorization can be multi-way (e.g., two-party mutual), e.g., so that the service consumer and the service provider authorize one another. The authentication may be anonymous, for example in the sense that NF service consumer and NF service provider identities are shielded from one another. Some embodiments may provide anonymous authorization or authentication for NF services by validating both the NF service consumers and NF service producers. Validating, verifying or authenticating an entity such as a service producer or service consumer may be considered to have the same meaning in various embodiments. The NF service producers and NF service consumers can thus be mutually validated to one another. This may occur when the NF consumer requests a NF service provided by a NF service producer.

Some embodiments may also provide for ID privacy of the NF service consumers and NF service producers. After mutual validation, the NF service consumers may obtain permissions to access the NF service producers with ID and service authorization information privacy protection. Security can be improved for example when NF service customers access NF services.

According to embodiments there is provided a method for network function (NF) service authorization in a network. The method may be performed by a NF service producer and a gateway (GW) of the network. The method includes, by the GW, receiving, from a NF service consumer, a service request for at least one NF service. The method further includes, by the GW, generating a temporary ID of the NF service consumer, a temporary ID of the NF service producer, and a first proof for use by the NF service producer to authenticate the NF service consumer. The method further includes, by the GW, sending an access request to the NF service producer. The access request may include at least one of: the first proof, the temporary ID of the NF service consumer, and the temporary ID of the NF service producer. In some embodiments, the access request may further include one, some or all of: one or more first proof parameters, NF service requirements, and a certificate of the GW. The method includes, by the NF service producer, receiving the access request and validating the first proof. In some embodiments, validating the first proof is based, at least in part, on the first proof parameters, or a permanent ID of the NF service producer, or a procedure, negotiated between the GW and the NF service producer, or a combination thereof. The method may further include, by the NF service producer, sending a response to the access request to the GW. The response may confirm results of the validating of the first proof.

In various embodiments, the method further includes, by the NF service producer, and prior said sending the response to the access request: authorizing the at least one NF service to be provided to the NF service consumer; and generating a second proof for use by the NF service consumer to authenticate the NF service producer and to access the NF service producer. In some further embodiments, the second proof may include a second proof authentication code, an indication of an algorithm to generate the second proof authentication code, processed service authorization attributes, and an expiry time of the second proof.

In various embodiments, the first proof parameters, and the first proof, are generated by the GW following a successful outcome of a discovery operation to discover the NF service producer providing the at least one NF service.

In various embodiments, the method further includes, by the GW, determining the NF service producer that is providing the at least one NF service before generating the first proof and the first proof parameters. In some embodiments, determining the NF service producer that providing the at least one NF service includes: discovering the NF service producer providing the at least one NF service through a discovery operation. Furthermore, the first proof and the first proof parameters are generated by the GW following a successful outcome of the discovery operation.

In various embodiments, the first proof includes a first proof authentication code or an indication of an algorithm to generate the first proof authentication code or both. In some embodiments, the first proof parameters, or the permanent ID of the NF service producer, or a NF service access window time, or a combination thereof may be input to and used by the algorithm to generate the first proof authentication code.

In various embodiments, the first proof may be used for producing a value to authenticate a NF service producer. The first proof may include a function or executable code which, when executed, produces a value usable to authenticate the NF service consumer.

In various embodiments, the second proof authentication code is generated based on the inputs to the algorithm, and the inputs are the temporary ID of the NF service consumer, the temporary ID of the NF service producer, the first proof, and the processed service authorization attributes.

In various embodiments, the processed service authorization attributes are provided by a hash function based on service authorization attributes, and the service authorization attributes are indicative of a permission for the NF service consumer to access the at least one NF service.

In various embodiments, the response to the access request includes the second proof, the processed service authorization attributes, and a certificate of the NF service producer, and the processed service authorization attributes are based at least in part on the NF service requirements.

In various embodiments, the first proof includes a function or executable code which, when executed, produces a value usable to authenticate the NF service producer. In various embodiments, the discovery operation is initiated by the service request for the at least one NF service. In various embodiments, after receipt of the service request from the NF service consumer and prior to initiating the discovery operation, the GW validates the NF service consumer. In various embodiments, the service request includes the NF service requirements, or a permanent ID of the NF service consumer, or a certificate of the NF service consumer, or a combination thereof.

In various embodiments, the first proof is for producing a value to authenticate the NF service provider. In some embodiments, the determining the NF service producer providing the at least one NF service is initiated in response to the service request for the at least one NF service. In some embodiments, after receipt of the service request from the NF service consumer and prior to said determining the NF service producer providing the at least one NF service, the GW validates the NF service consumer.

In various embodiments, following receipt of the response to the access request, the GW authorizes the at least one NF service to be provided to the NF service consumer, and the GW generates a third proof usable to authenticate the NF service producer by the NF service consumer. In various embodiments, the third proof includes a third proof authentication code, an indication of an algorithm to generate the third proof authentication code, the processed service authorization attributes, and an expiry time of the third proof; and the first proof parameters, or the first proof, or the processed service authorization attributes, or a combination thereof is input to and used by the algorithm to generate the third proof authentication code. In some embodiments, subsequently to generating the third proof, the GW sends to the NF service consumer a response to the service request.

In various embodiments, following receipt of the response to the access request, the GW validates the NF service producer based, at least in part, on a certificate of the NF service producer. In various embodiments, subsequently to validating the NF service producer (or in some cases subsequently to generating the third proof), the GW sends to the NF service consumer a response to the service request. In various embodiments, the response to the service request includes the first proof, or the second proof, or the third proof, or the first proof parameters, or the certificate of the GW, or a combination thereof. In various embodiments, subsequently to receiving the response to the service request from the GW, the NF service consumer validates the second proof or the third proof. In various embodiments, the third proof includes a function or executable code which, when executed, produces a value usable to authenticate the NF service producer.

In various embodiments, the method further includes, for example by the GW, establishing a secure communication tunnel between the NF service producer and the NF service consumer. The secure communication tunnel is established using the first proof parameters, or virtual IP addresses. In some such embodiments the method further includes, by the NF service producer, receiving a second access request for a following NF service from the GW. The second access request includes an authentication vector, or the first proof parameters, or a combination thereof. The method further includes, after receiving the second access request, validating the authentication vector. The method further includes, after validating the authentication vector, delivering the following NF service via the GW. In some embodiments, prior to sending the second access request to the NF service producer, the GW validates the authentication vector. In some embodiments, the GW validates the authentication vector in response to receipt of a service request (SR) for the following NF service from the NF service consumer, the SR including the authentication vector, or the first proof parameters, or a combination thereof. In some embodiments, in response the NF service producer providing the following NF service, or upon receipt of the following NF service, the GW forwards the following NF service to the NF service consumer.

In various embodiments, the method further includes establishing a secure communication tunnel between the NF service producer and the NF service consumer. The secure communication tunnel may be established using the first proof parameters, or virtual IP addresses.

In some embodiments, the method further includes, e.g., by the GW, receiving through the secure communication tunnel the service request (SR) for the following NF service from the NF service consumer. The SR includes an authentication vector. The method includes, following receipt of the SR for the following NF service and prior to providing the following NF service to the NF service consumer, validating the authentication vector. Th method further includes providing, by the NF service producer, the following NF service to the NF service consumer using the secure communication tunnel.

In various embodiments, prior sending the SR for the following NF service, the NF service consumer generates the authentication vector, the authentication vector being based at least in part on the second proof, or the first proof parameters, or the third proof, or a combination thereof.

According to embodiments of the present disclosure, there is provided another method for network function (NF) service authorization in a network. The method is performed by a gateway (GW) of the network. The method includes receiving, from a NF service consumer, a service request for at least one NF service. The method includes generating a temporary ID of the NF service consumer, a temporary ID of a NF service producer, and a first proof for use by the NF service producer to authenticate the NF service consumer. The method includes sending an access request to the NF service producer. The access request may include at least one of: the first proof, the temporary ID of the NF service consumer, and the temporary ID of the NF service producer. The access request may further include one or more of: one or more first proof parameters, NF service requirements, and a certificate of the GW. The method includes subsequently receiving a response to the access request from the NF service producer. The response confirms results of validation of the first proof by the NF service producer.

In various embodiments, the method further includes determining the NF service producer providing the at least one NF service before generating the first proof and the first proof parameters. In various embodiments, the determining the NF service producer providing the at least one NF service comprises discovering the NF service producer providing the at least one NF service through a discovery operation. In such embodiments, first proof and the first proof parameters are generated by the GW following a successful outcome of the discovery operation.

In various embodiments, the first proof parameters, and the first proof are generated by the GW following a successful outcome of a discovery operation to discover the NF service producer providing the at least one NF service.

In various embodiments, the first proof is for producing a value to authenticate the NF service producer. In various embodiments, the first proof includes a first proof authentication code or an indication of an algorithm to generate the first proof authentication code or both. Furthermore, the first proof parameters, or the permanent ID of the NF service producer, or a NF service access window time, or a combination thereof may be input to and used by the algorithm to generate the first proof authentication code.

In various embodiments, the discovery operation is initiated in response to the service request for the at least one NF service. In various embodiments, after receipt of the service request from the NF service consumer and prior to initiating the discovery operation, the GW validates the NF service consumer. In various embodiments, the service request includes the NF service requirements, or a permanent ID of the NF service consumer, or a certificate of the NF service consumer, or a combination thereof.

In various embodiments, following receipt of the response to the access request, the GW authorizes the at least one NF service to be provided to the NF service consumer, and the GW generates a third proof usable to authenticate the NF service producer by the NF service consumer. In various embodiments, the third proof includes a third proof authentication code, an indication of an algorithm to generate the third proof authentication code, the processed service authorization attributes, and an expiry time of the third proof. Furthermore, the first proof parameters, or the first proof, or the processed service authorization attributes, or a combination thereof may be input to and used by the algorithm to generate the third proof authentication code.

In various embodiments, following receipt of the response to the access request, the GW validates the NF service producer based, at least in part, on a certificate of the NF service producer. In various embodiments, subsequently to generating the third proof or validating the NF service producer, the GW sends to the NF service consumer a response to the service request. In various embodiments, the response to the service request includes the first proof, or the second proof, or the third proof, or the first proof parameters, or the certificate of the GW, or a combination thereof. In various embodiments, subsequently to receiving the response to the service request from the GW, the NF service consumer validates the second proof or the third proof.

According to embodiments of the present disclosure, there is provided another method for network function (NF) service authorization in a network. The method is performed by a NF service producer of the network. The method includes receiving an access request from a gateway (GW) of the network. The access request may include at least one of: a first proof, a temporary ID of an NF service consumer, and a temporary ID of the NF service producer. In various embodiments, the access request may include one or more of: one or more first proof parameters, NF service requirements, and a certificate of the GW. In some embodiments, the access request may be generated by the GW in response to a service request from the NF service consumer for at least one NF service. The method includes validating the first proof. In some embodiments, the validating is based, at least in part, on the first proof parameters, or a permanent ID of the NF service producer, or a procedure, negotiated between the GW and the NF service producer, or a combination thereof. The method includes sending a response to the access request to the GW. The response may confirm results of the validating of the first proof.

In some embodiments, prior to sending the access request, the GW determines the NF service producer providing the at least one NF service and generates the first proof and the first proof parameters. In some embodiments, determining by the GW the NF service producer providing the at least one NF service includes discovering the NF service producer providing the at least one NF service through a discovery operation.

In various embodiments, the above method includes, by the NF service producer, authorizing the at least one NF service to be provided to the NF service consumer. The method further includes, by the NF service producer, generating a second proof for use by the NF service consumer to authenticate the NF service producer and to access the NF service producer. The second proof includes a second proof authentication code, an indication of an algorithm to generate the second proof authentication code, processed service authorization attributes, and an expiry time of the second proof.

In various embodiments, prior to sending the access request, the GW generates a temporary ID of the NF service consumer, a temporary ID of the NF service producer, and the first proof for use by the NF service producer to authenticate the NF service consumer.

In various embodiments, the first proof parameters, and the first proof are generated by the GW following a successful outcome of a discovery operation to discover the NF service producer providing the at least one NF service.

In various embodiments, the first proof is for producing a value to authenticate the NF service producer. In various embodiments, the first proof includes a first proof authentication code or an indication of an algorithm to generate the first proof authentication code or both. Further, the first proof parameters, or the permanent ID of the NF service producer, or a NF service access window time, or a combination thereof is input to and used by the algorithm to generate the first proof authentication code.

In various embodiments, the second proof authentication code is generated based on the inputs to the algorithm, and the inputs are the temporary ID of the NF service consumer, the temporary ID of the NF service producer, the first proof, and the service authorization attributes. In various embodiments, the processed service authorization attributes are provided by a hash function based on service authorization attributes, the service authorization attributes indicative of a permission for the NF service consumer to access the at least one NF service. In various embodiments, the response to the access request includes the second proof, the processed service authorization attributes, and a certificate of the NF service producer. Further, the processed service authorization attributes may be based at least in part on the NF service requirements.

According to embodiments of the present disclosure, there is provided a system which includes at least a NF service producer and a gateway (GW) of a network. The GW is configured to receive, from a NF service consumer, a service request for at least one NF service. The GW is further configured to generate a temporary ID of the NF service consumer, a temporary ID of a NF service producer, and a first proof for use by the NF service producer to authenticate the NF service consumer. The GW is further configured to send an access request to the NF service producer. The access request may include at least one of: the first proof, the temporary ID of the NF service consumer, and the temporary ID of the NF service producer. In some embodiments, the access request further includes one or more of: one or more first proof parameters, NF service requirements, and a certificate of the GW. The NF service producer is configured to receive the access request, and validate the first proof. In various embodiments, the validating is based, at least in part, on the first proof parameters, or a permanent ID of the NF service producer, or a procedure, negotiated between the GW and the NF service producer, or a combination thereof. The NF service producer is further configured to send a response to the access request to the GW. The response confirms results of the validating of the first proof.

In various embodiments, the NF service producer is further configured to authorize the at least one NF service to be provided to the NF service consumer. In such embodiments, the NF service producer is further configured to generate a second proof for use by the NF service consumer to authenticate the NF service producer and to access the NF service producer. In various embodiments, the second proof includes a second proof authentication code, an indication of an algorithm to generate the second proof authentication code, processed service authorization attributes, and an expiry time of the second proof.

Other embodiments of the system can also be included, similar to those of the above-described method involving actions of the GW and the NF service producer.

According to embodiments of the present disclosure, there is provided a gateway (GW) apparatus in a network. The GW apparatus includes processing electronics and a network interface and is configured to receive, from a network function (NF) service consumer, a service request for at least one NF service. The GW apparatus is further configured to generate a temporary ID of the NF service consumer, a temporary ID of the NF service producer, and a first proof for use by the NF service producer to authenticate the NF service consumer. The GW apparatus is further configured to send an access request to a NF service producer. The access request may include at least one of: the first proof, the temporary ID of the NF service consumer, and the temporary ID of the NF service producer. In some embodiments, the access request further includes one or more of: one or more first proof parameters, NF service requirements, and a certificate of the GW. The GW apparatus is further configured to subsequently receive a response to the access request from the NF service producer. The response confirms results of validation of the first proof by the NF service producer.

Other embodiments of the GW apparatus can also be included, similar to those of the above-described method involving actions of the GW.

According to embodiments of the present disclosure, there is provided a network function (NF) service producer apparatus in a network. The NF service producer apparatus includes processing electronics and a network interface and is configured to receive an access request from a gateway (GW) of the network. The access request may include at least one of: a first proof, a temporary ID of the NF service consumer, and a temporary ID of the NF service producer. In some embodiments, the access request further includes one or more of: one or more first proof parameters, NF service requirements, and a certificate of the GW. The access request is generated by the GW in response to a service request from a NF service consumer for at least one NF service. The NF service producer is further configured to validate the first proof. In some embodiments, the validating is based, at least in part, on the first proof parameters, or a permanent ID of the NF service producer, or a procedure, negotiated between the GW and the NF service producer, or a combination thereof. The NF service producer may be further configured to send a response to the access request to the GW.

In various embodiments, the NF service producer is further configured to authorize the at least one NF service to be provided to the NF service consumer. In such embodiments, the NF service producer is further configured to generate a second proof for use by the NF service consumer to authenticate the NF service producer and to access the NF service producer. The second proof may include a second proof authentication code, an indication of an algorithm to generate the second proof authentication code, processed service authorization attributes, and an expiry time of the second proof.

Other embodiments of the NF service producer apparatus can also be included, similar to those of the above-described method involving actions of the NF service producer.

In accordance with embodiments, there is provided an electronic apparatus in a communication network, the apparatus comprising a processor, a network interface and a memory and configured to perform one or more of the methods as described herein. In accordance with embodiments, there is provided a system of such electronic apparatuses, networked together and configured to interact to perform one or more of the methods as described herein.

In accordance with an embodiment of the present disclosure, there is provided a computer program product comprising a (e.g., non-transitory) computer readable medium having statements and instructions stored thereon which, when executed by one or more computer processors, cause the computer processors to perform the method as set forth above. The computer processors may be parts of one or more electronic apparatuses (e.g., network entities) as described herein.

Embodiments have been described above in conjunctions with aspects of the present applicationupon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present application will become apparent from the following detailed description, taken in combination with the appended drawings, in which:

FIG. 1 shows an example anonymous authorization process flow according to some embodiments of the present disclosure.

FIG. 2 shows an example anonymous authorization process flow according to some other or further embodiments of the present disclosure.

FIG. 3 shows an example of anonymous authorization for an NF service triggered by an initial service request, according to some embodiments of the present disclosure.

FIG. 4 shows a call flow diagram for an anonymous authorization process by the NF service producer, according to some embodiments of the present disclosure.

FIG. 5 shows a call flow diagram for an anonymous authorization process by the NF service producer, according to some other embodiments of the present disclosure.

FIG. 6 shows a call flow diagram for an anonymous authorization process by the NF service producer, according to some other embodiments of the present disclosure.

FIG. 7 illustrates an electronic device which may be configured to perform operations according to embodiments of the present disclosure.

It will be noted that throughout the appended drawings, like features are identified by like reference numerals.

### DETAILED DESCRIPTION OF ILLUSTRATIVE EMBODIMENTS

This disclosure assumes that NF service producers and NF service consumers may be deployed by different providers, owners or other similar entities. The NF service producers may be entities (e.g., network functions, devices, etc.) which provide a network function, which may be a component of a network infrastructure having a specific functional behaviour. The NF service consumers may be entities (e.g., other network functions or devices) which utilize the provided network function, and thus receive and make use of the NF service. The NF service producers and the NF service consumers, or their deployers, may not trust each other. In this disclosure, the NF service producers and the NF service consumers may be connected to a GW (GateWay) which may be a network function. A GW may act as an intermediary between NF service producers and consumers. As part of this action, the GW may convert information between two protocol formats so as to allow the NF service producers and consumers to communicate. The GW may serve as a single point through which communication between the NF service producer and consumer passes. The NF service consumers and the NF service producers can connect to the GW. An Authentication, Authorization and Access (or Accounting) (AAA), which is a trusted third function, may also be connected to GW to provide authentication and similar services. The AAA may handle requests for access to network resources, as well as authenticating the entities making the requests, determining whether the entities or requests are authorized, and blocking or allowing the requests based on such determination. The AAA may also track and maintain a record of such requests for accounting purposes. The NF service producers, the NF service consumers and the GW may be registered to the AAA, and may obtain certificates, published by the AAA. Secure communication channels between the NF service consumers and the GW, and between the NF service producers and the GW may be provided or established. It should be noted that the name of each function is merely an example, the name may change.

Embodiments of the present disclosure involve anonymous authorization, enabling NF service consumers and NF service producers to attain mutual validation when a NF service consumer requests NF services. After mutual validation, the NF service consumer may obtain permissions to access NF service producers while also providing ID privacy protection and service authorization information privacy protection. Embodiments may provide for methods and systems configured to implement the anonymous authorization methods. Embodiments may provide for a mechanism for validating NF service producers and consumers prior to the NF services being accessed (e.g., provided by producer to consumer). Embodiments provide for methods, apparatus and systems to generate proofs for facilitating access by a NF service consumer to the NF services. Embodiments provide for methods, apparatus and systems to protect ID privacy during the authentication or authorization procedure.

In various embodiments, a proof may be considered to be similar to an authentication token. As will be readily understood, token-based authentication allows devices to receive a unique access token upon verification (validating or authenticating) of identity. In contrast to a token, the proof may be a function, or a code. If some actions occur between two entities, one or both of them may implement (execute) the proof. This may involve calculating or executing the proof (function or code) to obtain a value. This value can then be compared to stored information for authentication (i.e. validation or verification) purposes. Accordingly a proof may include a function or executable code which, when executed, produces a value usable to authenticate an entity. As an example, a proof may be or include a hash function, or associated code which when executed performs the hash function. The proof thus generates a hashed value and the hashed value may be an authentication code.

Some embodiments provide for a GW coupled to a NF service consumer and to a NF service producer. The GW may receive a service request from the NF service consumer. Following the service request receipt (or prior the service request receipt, or simultaneously) the GW may implement discovery of NF service producers in accordance with subscriptions from the NF service producers. The discovery may determine NF service producers which may potentially fulfill the service request. The GW may generate a first proof which is used to validate the NF service consumer. The NF service producer may implement authorization for (e.g., fine-grain) services to the NF service consumer, and may also generate a second proof indicating a permission to access the NF service producer's services. That is, via the second proof, and more particularly via service authorization attributes of the second proof, the NF service producer may grant a permission to the NF service consumer, where the permission is to access the NF service. Accordingly, the NF service producer can provide service authorization for the NF service consumer. The NF service consumer may validate the second proof and subsequently access the NF services of the NF service producer. Coarse-grained services are typically larger components than fine-grained services and have larger subcomponents. A coarse-grained service may wrap one or more fine-grained services together into a more coarse-grained operation. Fine-grained services may be smaller components of which the larger (e.g., coarse-grained) services are composed, and may be lower-level services for example.

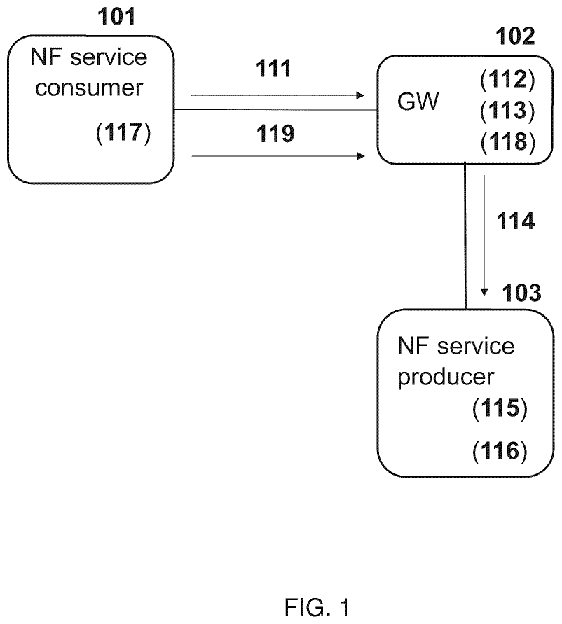

FIG. 1 shows an example of anonymous authorization process flow in accordance with some embodiments. Here and elsewhere, although not necessarily described in detail, entities can take other actions (e.g., process abort) upon a failure, such as a failure to validate or identify an entity. The network includes the NF service consumer 101, the GW 102, and the NF service producer 103. Each of these network components may be an electronic device including at least processing electronics and a network interface. The NF service consumer requests service by sending a service request 111 to the GW. The GW implements discovery 112 of NF service producers, and generates 113 a first proof for the NF service producer to authenticate the NF service consumer. The GW sends an access request 114 to the NF service producer. The access request includes the first proof and may include additional information such as but not necessarily limited to a temporary ID of the NF service consumer and a temporary ID of the NF service producer. Responsive to the access request from the GW, the NF service producer implements authorization 115 for fine-grain services, and generates 116 a second proof for authorization. The authorization may be implemented at least in part by validating the first proof. This authorization provides a permission for the NF service consumer to access the NF services. The second proof is related to service authorization attributes. The NF service consumer validates 117 the first proof (as received from the GW for example in a service response message that corresponds to the service request message) and the second proof (as received from the NF service producer via the GW). The GW sets up 118 a secure tunnel between the NF service consumer and the NF service producer. The NF service consumer sends 119 the second proof through the secure tunnel to access NF services provided by the NF service producer. Accordingly, embodiments provide for an anonymous authentication or authorization procedure by which NF service consumers and NF service producers may be mutually validated when the NF service consumer requests NF services. After mutual (i.e. two-way) validation, the NF service consumer may obtain permissions to access one or more NF service producers, while being provided with identity privacy protection, service authorization information privacy protection, or both. According to privacy protection, the NF service consumer, the NF service producer, or both, may interact with its counterpart NF service producer or NF service consumer, respectively, without necessarily exposing its true identity or other private information to such a counterpart.

In some instances, the NF service producer may not necessarily be the one to grant a permission to the NF service consumer to access its NF services. In this case, the GW may generate a third proof which includes service authorization attributes from the NF service producer. The GW may operate to grant (or deny) the appropriate permissions.

In some embodiments, to protect ID privacy and service authorization information privacy, the GW may generate temporary ID for the NF service consumer and temporary ID for the NF service producer. The temporary IDs may be used to facilitate anonymous authorization for providing or using NF services. The temporary IDs may be used for communication and generation of the first proof and the second proof. The temporary IDs may be generated by the GW and subsequently used in generation of the first proof, second proof, or both.

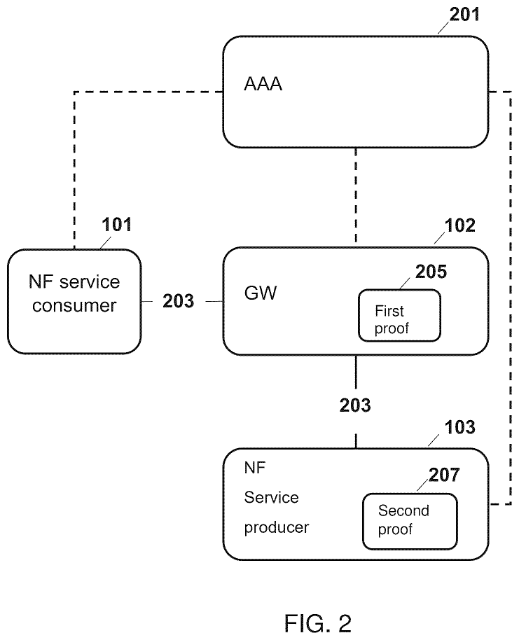

FIG. 2 shows another embodiment of a system and method for anonymous authorization for an NF service. The system includes the NF service consumer 101 and the NF service producer 103. As before, the NF service consumer and the NF service producer may be deployed by different providers, and they may not trust each other. The NF service producer 101 and the NF service consumer 103 are connected (communicatively coupled) to the GW 102. Secure communication channels 203 may connect the NF service consumer 101 and the NF service producer 103 to the GW 102. The AAA 201 is also connected to the GW 102 to provide authentication for the NF service producer 101 and the NF service consumer 103. The NF service producer, NF service consumer, and GW may be registered to the AAA, and, upon successful registration, these network entities may obtain their own certificates published by the AAA 201.

According to the embodiment, the NF service consumer 101 may perform the following actions. The NF service consumer sends to GW an initial service request for a NF service by the NF service producer 103. The NF service consumer validates the NF service producer 103. The NF service consumer may subsequently send a following service request for the same NF service, where the following service request includes a processed second proof.

The GW 102 may perform the following actions. The GW validates the NF service consumer 101 and the NF service producer 103. The GW implements discovery of the NF service producer 103. The GW generates a first proof 205 used for validation (e.g., authentication) on the NF service consumer 101. The GW generates temporary IDs for the NF service consumer 101 and the NF service producer 103. A temporary ID may be used as an alias for its associated entity. The GW establishes a secure tunnel between the NF service consumer 101 and NF service producer 103. The GW may generate a third proof with service authorization attributes. If, as described elsewhere, the NF service consumer transmits a following service request, e.g., a subsequent request for the same service, the GW may validate the third proof in response to the following service request from the NF service consumer.

The NF service producer 103, in accordance with the embodiment, may perform the following actions. The NF service producer validates the first proof 205, thus validating or authenticating the NF service consumer 101. The NF service producer generates a second proof 207 with service authorization attributes. The NF service producer can implement service authorization, for example to authorize the NF service consumer to access services of the NF service producer. The NF service producer validates the processed second proof 207. The NF service producer provides the NF service to the NF service consumer 101 after validation.

The AAA 201 may perform the following actions. The AAA may register the NF service producer 103, NF service consumer 101, and the GW 102. The AAA may facilitate secure communication between the NF service producer 103 and the GW 102. The AAA may facilitate secure communication between the NF service consumer 101 and the GW 102. The AAA's actions may be according to conventional roles performed by AAA.

In accordance with the presently illustrated embodiment the NF service consumer 101 may transmit a service request (i.e. a request for a service) to the GW 102. Responsive to the request from the NF service consumer 101, the GW 102 may validate the NF service consumer 101, and may also implement a discovery operation to discover appropriate NF service producers for providing the service (e.g., the NF service producer 103). The discovery operation may use information provided in accordance with subscriptions from the NF service producers. The GW 102 may generate a first proof 205 for use by the NF service producer 103 to authenticate the NF service consumer 101. Responsive to an access request from the GW 102, the NF service producer 103 may implement authorization for fine-grain services, and generate a second proof 207 for authorization. This second proof 207 may include or be related to service authorization attributes. This authorization may provide a permission for the NF service consumer 101 to access the NF services. The NF service consumer 101 may validate the first proof 205 and the second proof 207.

The GW 102 may establish a secure tunnel between the NF service consumer 101 and the NF service producer 103. The NF service consumer 101 may send the second proof 207 through the secure tunnel to access the NF services by the NF service producer 103. In some embodiments, the GW 102 may generate a third proof which includes service authorization attributes from the NF service producer 103. In some embodiments, to protect ID privacy and service authorization information privacy (anonymous authorization), the GW 102 may generate temporary IDs for the NF service consumer 101 and the NF service producer 103. The temporary IDs may be used for communication and generation the first proof 205 and the second proof 207. The GW 102 validates the NF service consumer 101 and the NF service producer 103 on behalf of the AAA 201, by means of the first proof 205's generation which may be used for validation. Off-line authentication of the NF service consumer 101 and the NF service producer 103 may be accomplished without involvement of the AAA 201.

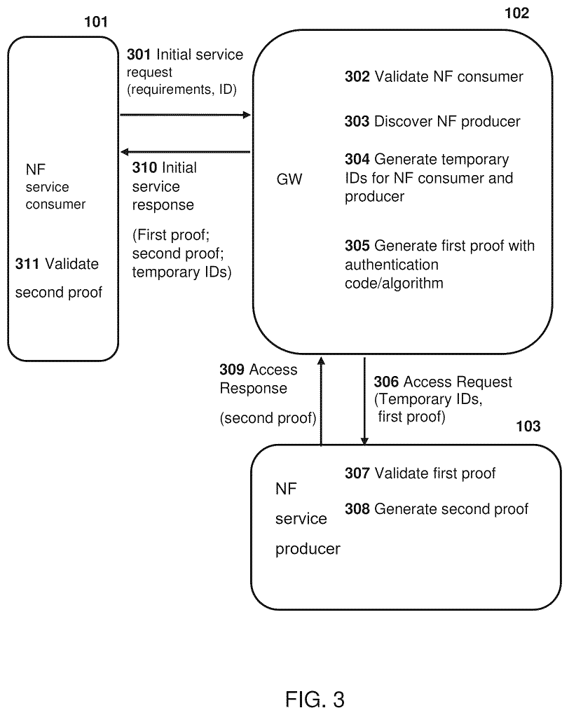

FIG. 3 illustrates anonymous authorization for an NF service, triggered by an initial service request, according to an embodiment of the present disclosure. As illustrated, the NF service consumer 101 sends an initial NF service request 301. This request 301 may include service requirements and an ID (e.g., a permanent ID) of NF service consumer. This request may include a certificate of NF service consumer, which may be published by the AAA entity (not shown) after registration to the AAA entity. Next, upon receipt of the initial service request, the GW 102 validates 302 the NF service consumer, for example based on the certificate included in the initial service request.

Next, the GW 102 initiates a discovery operation 303 to identify an appropriate NF service producer 103, such that the identified NF service producer can provide the service identified in the request 301. In some embodiments, the GW 102 may have service agreements (or subscriptions) with one or more candidate NF service producers, including the NF service producer 103, and the GW may select the NF service producer from among these candidate NF service producers. The GW may select the NF service producer 103 according to service requirements included in the NF service request 301. In other embodiments, the GW 102 may not necessarily have service agreements with NF service producers. In this case, the GW may initiate another network function to perform the discovery operation to identify and select the NF service producer 103 from among one or more candidate NF service producers.

Next, the GW 102 generates 304 a temporary ID for the NF service consumer 101, and the GW generates another temporary ID for NF service producer 103.

The GW 102 also generates 305 a first proof. This first proof is used to authenticate the NF service consumer 101 by the NF service producer 103. The first proof may include an authentication code or an algorithm of generation of the authentication code. The authentication code may be generated based on input including the temporary ID of NF service consumer, the real ID of NF service producer, the temporary ID of NF service producer, or the like, or a combination thereof.

The GW 102 then sends an access request 306 to the previously selected NF service producer 103. This access request 306 may include the first proof, service requirements, the temporary ID for NF service consumer, or the temporary ID for NF service producer, or a combination thereof.

Following receipt of the access request 306, the NF service producer 103 validates 307 the first proof. This validation may be performed according to the temporary ID for the NF service consumer, the temporary ID for the NF service producer, and the real ID of the NF service producer. It is noted that the real IDs may be permanent IDs, whereas the temporary IDs may be used to identify the NF service producer to the NF service consumer and/or vice-versa, and subsequently discarded, so as to maintain anonymity between the NF service consumer and NF service producer. For example, if the first proof (e.g., algorithm) is a hash function, the NF service producer computes a hashed value with the input of: {NF service's temporary ID, the real ID of NF service producer, the temporary ID of NF service producer}. The NF service producer compares the hashed value with the received first proof. If the comparison produces a match, the NF service producer accepts the first proof.

After a successful validation, the NF service producer 103 may then determine to provide the requested NF service to the NF service consumer 101, according to its service requirements and its capabilities. The NF service producer then generates 308 a second proof. This second proof is used to authenticate NF service producer 103 by the NF service consumer 101. This second proof may include an authentication code or an algorithm usable for generation of the authentication code. The second proof may include or indicate processed service authorization attributes, a lifetime of the second proof, or the like, or a combination thereof. The authentication code indicated by the second proof may be generated based on information such as the temporary ID of the NF service consumer, the temporary ID of the NF service producer, the first proof, and the service authorization attributes. The service authorization attributes may be processed using a function (e.g., a hash function) to obtain the processed service authorization attributes. The service authorization attributes may indicate details of a permission for the NF service consumer 101 to access the NF services of the NF service producer 103. Such details may include, for example, the time, the service location, how the access is to be performed, conditions to be satisfied in order for access to be granted, a service authorization description, or the like, or a combination thereof.

The NF service producer 103 then sends a response 309 to the GW 102. This response is for confirming results of validating the first proof, the response 309 may include the second proof.

The GW 102 then sends an initial service response 310 to NF service consumer 101. This initial service response may include information such as the first proof, the second proof, the temporary ID for NF service consumer, the temporary ID for NF service producer, a GWs certificate published by AAA, or the like. The NF service consumer then validates 311 the second proof.

In some embodiments, if there is no secure (or insufficiently secure) communication between the NF service consumer and the GW, or no secure (or insufficiently secure) communication between the NF service producer and the GW, messages between the NF service consumer and the GW, or messages between the NF service producer and the GW, or both may be signed to increase security. For example, the access response may be signed by the NF service producer's private key, and then the GW may validate the signed access response using the NF service producer's public key.

In some embodiments, when the NF service consumer requests a following (subsequent) service request which indicates a request for the same service (i.e. the same service as previously requested), the NF service consumer generates an authentication vector based on the second proof. The GW may forward the request to the NF service producer. The NF service producer may then validate the authentication vector and provide NF services to the NF service consumer. An authentication vector may include or indicate a value calculated by an entity such as the NF service consumer. For example, the authentication vector may be a hash value with the input of the second proof and the NF service consumer's temporary ID. The authentication vector may be associated with the NF service consumer's temporary ID and the second proof from the NF service producer.

According to embodiments of the present disclosure, therefore, the GW authenticates the NF service consumer and the NF service producer on behalf of an AAA. This authentication involves generating a first proof used for validation. This approach may facilitate off-line authentication for NF service consumers and NF service producers without direct involvement of the AAA. According to embodiments, the GW generates temporary IDs for the NF service consumer and the NF service producer, thus facilitating anonymous authorization for NF services.

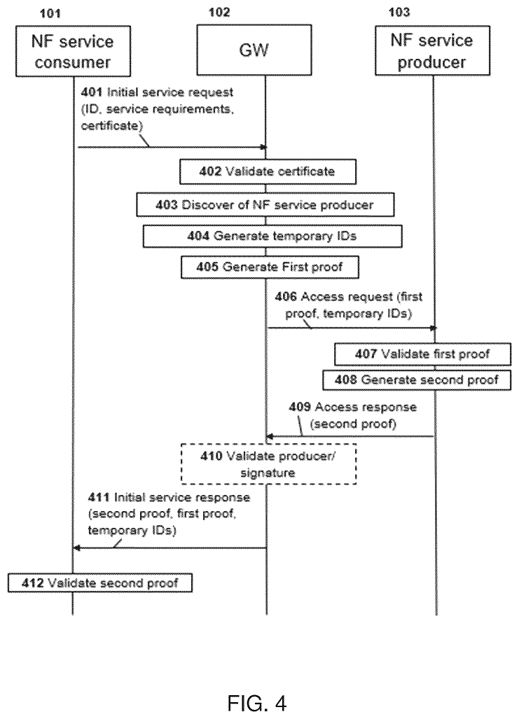

FIG. 4 illustrates a call flow for an anonymous NF service authorization procedure, according to an embodiment. This procedure may be triggered when an NF service consumer 101 initially requests at least one NF service. In this embodiment, the NF service producer 103 is assumed to grant a permission to the NF service consumer 101 to access its NF services.

In the embodiment of FIG. 4, the NF service consumer 101 sends an initial service request 401 to the GW 102. This initial service request 401 may include an ID of the NF service consumer and NF service requirements. The service request includes the NF service consumer's certificate which may be published by the AAA. In some embodiments, if there is no secure communication channel (or security is insufficient) between the NF service consumer and the GW, the NF service consumer and the GW may negotiate and establish a secure communication channel before the initial service request is sent.

Next, the GW may validate 402 the certificate included in the service request, for example using a public key provided by the AAA. If there is no secure communication channel (or security is insufficient), the GW 102 may validate the NF service consumer 101 using information that was negotiated before sending the initial service request 401.

Next, the GW may implement discovery 403 on the NF service producer. That is, the GW performs a discovery operation in order to identify (discover) the NF service producer as having desirable properties and capabilities (e.g., providing the requested NF service), for example from among plural candidate NF service producers. The discovery operation may be similar to the discovery operation 303 of FIG. 3 and may be initiated by or in response to the service request.

Next, the GW generates 404 a temporary ID of the NF service consumer and another temporary ID for the (e.g., discovered and selected) NF service producer 103 which is to provide the requested service.

Next, the GW generates 405 a first proof. This operation may be similar to the generation operation 305 of FIG. 3. The first proof may be for use by the NF service producer 103 to authenticate the NF service consumer 101. The GW may generate the first proof and the first proof parameters following a successful outcome of the discovery operation. The first proof may include a first proof authentication code or an indication of an algorithm usable to generate the first proof authentication code. The first proof parameters, or the permanent ID of the NF service producer, or a NF service access window time, or a combination thereof, may be input to and used by the algorithm to generate the first proof authentication code.

The GW 102 then sends an access request 406 to the previously selected NF service producer 103. This access request 406 may include the first proof, one or more first proof parameters, NF service requirements, a certificate of the GW 102, the temporary ID for NF service consumer, or the temporary ID for NF service producer, or a combination thereof (e.g., all of the listed items). In some embodiments, the access request 406 includes the certificate which is published by AAA. This is the GW's certificate as provided by the AAA when the GW registers to the AAA, and which is kept in the GW. In some embodiments, if there is no existing or sufficiently secure communication channel between NF service producer and GW, the NF service producer and the GW negotiate such a secure communication channel before the access request 406 is sent toward and received by the NF service producer 103.

Following its receipt of the access request 406, the NF service producer 103 may validate the GW based on the received certificate or information negotiated between the NF service producer 103 and the GW 102 for example during a secure communication channel setup. This information may include a signature from the GW. Alternatively, the access request may be signed by the GW's private key. The NF service producer also validates 407 the first proof. This validation may be performed according to the temporary ID for the NF service consumer, the temporary ID for the NF service producer, and the real ID of the NF service producer. The first proof may be validated based at least in part on the first proof parameters, or a permanent ID of the NF service producer, or a procedure negotiated between the GW and the NF service producer, or the like, or a combination thereof.

The NF service producer 103 may then determine to provide the requested NF service to the NF service consumer 101, subject to the NF service producer's service requirements and its capabilities. This may include authorizing the requested NF service to be provided to the NF service consumer. For example, after validating the first proof, the NF service provider may grant a permission to access a service, such that at least one NF service is authorized to be provided. The NF service producer then generates 408 a second proof. Generation of the second proof may be similar to generation 308 of the second proof as described with respect to FIG. 3. The second proof may be for use by the NF service consumer to authenticate the NF service producer and to access the NF service producer. The second proof may include a second proof authentication code, an indication of an algorithm to generate the second proof authentication code, processed service authorization attributes, and an expiry time of the second proof. The second proof authentication code may be generated based on the inputs to the algorithm, such as the temporary ID of the NF service consumer, the temporary ID of the NF service producer, the first proof, and the service authorization attributes. The granted permission to access the service may be included, implicitly or explicitly, in the second proof.

The NF service producer 103 then sends an access response 409 to GW 102. This access response 409 may include the second proof. In some embodiments, this response may include a certificate of the NF service producer, which is published by the AAA. The response may include the second proof, the certificate, the processed service authorization attributes (which may be based at least in part on the NF service requirements), or a combination thereof.

The GW 102 may validate 410 the NF service producer 103 based on the certificate included in the access response 409, or based on information negotiated between the NF service producer 103 and the GW 102 during a secure communication channel setup. This negotiated information may include a signature from the GW 102, or the access response may be signed by the GW's private key. The negotiated information may be a secret value known only by the NF service producer and the GW.

The GW 102 then sends an initial service response 411 to the NF service consumer 101. This initial service response may include information such as the first proof, the second proof, the first proof parameters, the temporary ID for the NF service consumer, the temporary ID for the NF service producer, or the like. In some embodiments, the initial service response 411 may include the GW's certificate which is published by the AAA. In some embodiments, if there is no existing secure communication channel between the NF service consumer and the GW, such a secure communication channel may be negotiated and established before the initial service request 401 is sent.

The NF service consumer 101 then validates the GW, validates 412 the second proof, and retains the second proof and temporary ID.

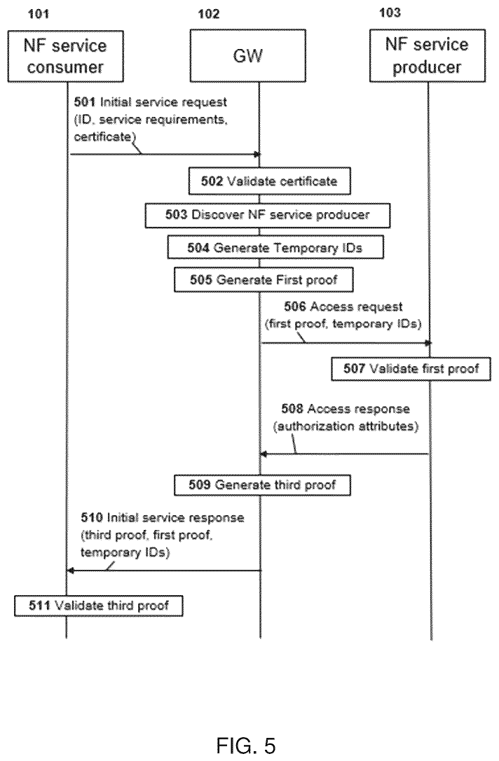

FIG. 5 illustrates a call flow for an anonymous authorization procedure, according to an embodiment. In this illustrated procedure, the GW performs authorization, e.g., granting a permission to an NF service consumer to access NF services. The procedure is triggered when an NF service consumer initially requests NF services from the network.

In the embodiment of FIG. 5, the NF service consumer 101 sends an initial service request 501 to the GW 102. This service request may include an ID of the NF service consumer, NF service requirements, and a certificate for the NF service consumer.

Next, the GW 102 validates 502 the certificate using an AAA's public key. If there is no secure (or insufficiently secure) communication, the GW 102 validates the NF service consumer 101 using information that was negotiated between the GW and NF service consumer, before the NF service consumer sent the initial service request.

Next, the GW 102 implements discovery 503 on the NF service producer 103, for example similarly to discovery 303 and 403 of FIG. 3 and FIG. 4.

Next, the GW 102 generates 504 a temporary ID for the NF service consumer, and another temporary ID for the discovered and selected NF service producer 403.

Next, the GW 102 generates 505 a first proof. The first proof may include an authentication code or an algorithm of generation of the authentication code. The authentication code may be generated based on input including the temporary ID of the NF service consumer, the real ID of the NF service producer, the temporary ID of the NF service producer, and a window time which indicates a permission to access its NF service during a period of time.

The GW then sends an access request 506 to the NF service producer. This access request 506 may include the first proof, service requirements, the temporary ID for the NF service consumer, and the temporary ID for the NF service producer.

The NF service producer 103 then validates the GW based on the received certificate or based on information negotiated between the NF service producer and the GW during a secure communication channel setup.

The NF service producer validates 507 the first proof for example by comparing the received authentication code with the value calculated by executing the first proof, where the first proof may be executed using the inputs of the temporary ID of the NF service consumer, the real ID of the NF service producer, and the temporary ID of the NF service producer.

The NF service producer 103 then sends a response 508 to the GW 102. This response 508 may include service authorization attributes based on the service requirements.

The GW 102 then determines to provide (or facilitate provision of) NF services to the NF service consumer 101. This may involve the GW 102 authorizing the NF service to the NF service consumer. The GW 102 then generates 509 a third proof. This third proof is used to authenticate the NF service producer 103 by the NF service consumer 101. This third proof may include an authentication code, an indication of an algorithm used to generate the authentication code, processed service authorization attributes, and an expiry time (or lifetime) of the third proof. The authentication code may be generated based on input such as the temporary ID of NF service consumer, the temporary ID of NF service producer, the first proof, or the service authorization attributes, or a combination thereof.

The GW 102 then sends an initial service response 510 to the NF service consumer 101. This response may include the first proof, the third proof, the temporary ID for NF service consumer, and the temporary ID for NF service producer.

The NF service consumer 101 then validates the GW, validates 511 the third proof, and retains the third proof and the temporary IDs.

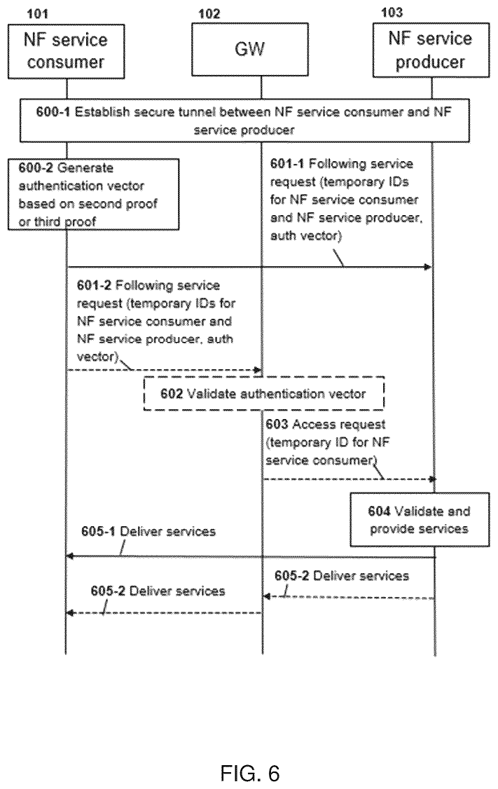

FIG. 6 illustrates a call flow for an anonymous authorization procedure, in relation to an NF service triggered by a following service request. In this sense, the term “following service request” indicates that the NF service consumer requests the same NF services which were also indicated in a prior service request by the NF service consumer.

According to FIG. 6, the GW 102 establishes 600-1 a secure communication tunnel between the NF service consumer 101 and the NF service producer 103. The secure communication tunnel may be established using existing techniques. For example, the secure communication tunnel may be set up with the help of the GW 102 using a virtual IP address, or temporary IDs, where the virtual IP address may be created by transforming real address values into a pseudo-value, and virtual IP addresses may be mapped to temporary IDs. The secure communication tunnel may be established using the first proof parameters, or virtual IP addresses, or both.

The NF service consumer then generates 600-2 an authentication vector. The authentication vector may be generated based on input such as the second proof, a temporary ID of the NF service consumer, or a temporary ID of the NF service producer, or a combination thereof. In other embodiments, authentication vector may be generated on input such as the third proof, a temporary ID of NF service consumer, or a temporary ID of NF service producer, or a combination thereof. The authentication vector may be based at least in part on first proof parameters.

Next, the NF service consumer 101 may send a following service request 601-1 or 601-2 to the GW 102. If the authentication vector is generated based in part on the second proof, then the following service request 601-1 is sent. Otherwise, if the authentication vector is generated based in part on the third proof, then the following service request 601-2 is sent. The following service request 601-1 or 601-2 may include the authentication vector, the temporary ID of NF service producer, and the temporary ID of NF service producer. This following service request 601-1 is delivered to the NF service producer 103 directly through the secure tunnel between the NF service consumer 101 and the NF service producer 103.

If the authentication vector is an output of the third proof, the following service request 601-2 may be delivered to the GW directly. In this case, the GW 102 validates 602 the authentication vector. Then the GW 102 sends an access request 603 to the NF service producer 103. This access request 603 may include the temporary ID of the NF service producer 101. The access request 603 may include an authentication vector, or the first proof parameters, or both. The GW may validate the authentication vector in response to receipt of a service request (SR) for the following NF service from the NF service consumer. The SR may include the authentication vector, or the first proof parameters, or a combination thereof.

In case of either the following service request 601-1 or 601-2, the NF service producer 103 validates 604 the authentication vector. Then, the NF service producer provides the requested services. This may involve the NF service producer 103 delivering 605-1 NF services to the NF service consumer 101 through the secure tunnel. Additionally or alternatively, this may involve the NF service producer 103 delivering 605-2 NF services to the NF service consumer 101 through the GW 102. That is, the GW may receive the NF service and then forward it to the NF service consumer.

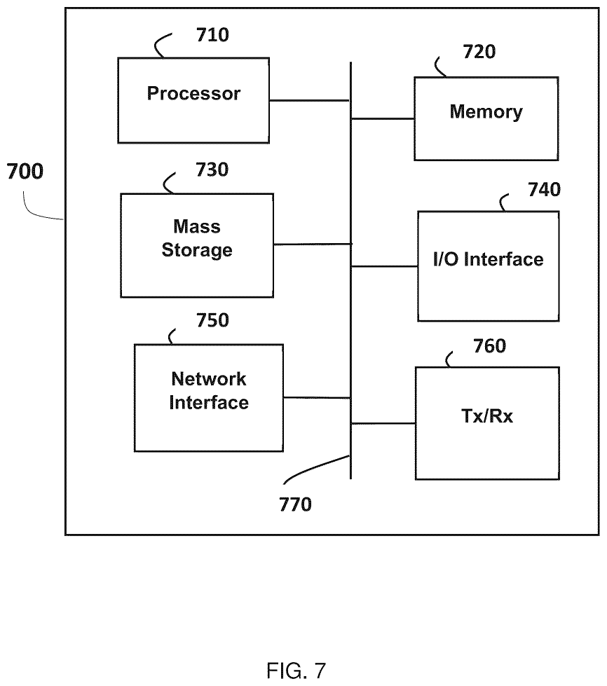

FIG. 7 is a schematic diagram of an electronic device 700 that may perform any or all of operations of the above methods and features explicitly or implicitly described herein, according to different embodiments of the present disclosure. For example, a computer equipped with network function may be configured as an electronic device 700. Such an electronic device may be used as part of one or more of: a controller, an edge server, a processing device, a bounding region module, an AV, an RSU, etc.

As shown, the device includes a processor 710, such as a Central Processing Unit (CPU) or specialized processors such as a Graphics Processing Unit (GPU) or other such processor unit, memory 720, non-transitory mass storage 730, I/O interface 740, network interface 750, and a transceiver 760, all of which are communicatively coupled via bi-directional bus 770. According to certain embodiments, any or all of the depicted elements may be utilized, or only a subset of the elements. Further, the device 700 may contain multiple instances of certain elements, such as multiple processors, memories, or transceivers. Also, elements of the hardware device may be directly coupled to other elements without the bi-directional bus. The processor and memory may form part or all of processing electronics of the device. Additionally or alternatively to a processor and memory, other processing electronics, such as integrated circuits, analog circuits, digital circuits, microchips, application specific integrated circuits, field programmable gate arrays, or the like, or a combination thereof, may be employed for performing the required operations of devices and systems as described herein.

The memory 720 may include any type of non-transitory memory such as static random access memory (SRAM), dynamic random access memory (DRAM), synchronous DRAM (SDRAM), read-only memory (ROM), any combination of such, or the like. The mass storage element 730 may include any type of non-transitory storage device, such as a solid state drive, hard disk drive, a magnetic disk drive, an optical disk drive, USB drive, or any computer program product configured to store data and machine executable program code. According to certain embodiments, the memory 720 or mass storage 730 may have recorded thereon statements and instructions executable by the processor 710 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of embodiments of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include a number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of embodiments of the present application as defined by the appended claims, and are contemplated to cover any and all modifications, variations, combinations or equivalents that fall within the scope of the present application.

Embodiments have been described above in conjunction with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

It should be noted that one or more steps in each embodiment can be skipped in some modified embodiments, and one or more steps in each embodiment can be separated from the embodiment to be an independent technical solution. The sequence of the steps in each embodiment can be changed in some modified embodiments in a reasonable manner.

What is claimed is:

1. A method for network function (NF) service authorization in a network, the method comprising:
receiving, by a gateway (GW) of the network, from an NF service consumer, a service request for at least one NF service;
generating, by the GW, a temporary identifier (ID) of the NF service consumer, a temporary ID of an NF service producer of the network, and a first proof for use by the NF service producer to authenticate the NF service consumer;
sending, by the GW, an access request to the NF service producer, the access request including at least one of: the first proof, the temporary ID of the NF service consumer, or the temporary ID of the NF service producer;
receiving, by the NF service producer, the access request;
validating, by the NF service producer, the first proof; and
sending, by the NF service producer, a response to the access request to the GW, the response confirming results of said validating.

2. The method of claim 1, wherein the access request further includes at least one of: one or more first proof parameters, NF service requirements, or a certificate of the GW.

3. The method of claim 2, wherein said validating the first proof is based, at least in part, on at least one of the one or more first proof parameters, a permanent ID of the NF service producer, or a procedure negotiated between the GW and the NF service producer.

4. The method of claim 3, further comprising, prior to said sending the response to the access request:
authorizing, by the NF service producer, the at least one NF service to be provided to the NF service consumer; and
generating, by the NF service producer, a second proof for the NF service consumer to authenticate the NF service producer and to access the NF service producer.

5. The method of claim 4, wherein the second proof includes at least one of a second proof authentication code, an indication of an algorithm to generate the second proof authentication code, processed service authorization attributes, or an expiry time of the second proof.

6. The method of claim 1, wherein the first proof includes a first proof authentication code or an indication of an algorithm to generate the first proof authentication code or both.

7. The method of claim 5, wherein the second proof authentication code is generated based on inputs to the algorithm, and wherein the inputs include at least one of a temporary ID of the NF service consumer, a temporary ID of the NF service producer, the first proof, or the processed service authorization attributes.

8. The method of claim 5, wherein:
the response to the access request includes the second proof, the processed service authorization attributes, and a certificate of the NF service producer; and
the processed service authorization attributes are based at least in part on the NF service requirements.

9. The method of claim 5, further comprising, after receiving the response to the access request:
authorizing, by the GW, the at least one NF service to be provided to the NF service consumer; and
generating, by the GW, a third proof usable to authenticate the NF service producer by the NF service consumer.

10. The method of claim 9, wherein:
the third proof includes a third proof authentication code, an indication of an algorithm to generate the third proof authentication code, the processed service authorization attributes, and an expiry time of the third proof; and
the algorithm uses at least one of the first proof parameters, the first proof, or the processed service authorization attributes as an input to generate the third proof authentication code.

11. The method of claim 2, further comprising:
establishing, by the GW, a secure communication tunnel between the NF service producer and the NF service consumer, the secure communication tunnel established using the first proof parameters or virtual IP addresses.

12. The method of claim 11, further comprising:
receiving, by the NF service producer, a second access request for a following NF service from the GW, the second access request including at least one of an authentication vector or the first proof parameters;
subsequent to receiving the second access request, validating, by the NF service producer, the authentication vector; and
subsequent to validating the authentication vector, delivering, by the NF service producer, the following NF service via the GW.

13. The method of claim 12, further comprising:
validating, by the GW, the authentication vector in response to receipt of a service request (SR) for the following NF service from the NF service consumer, the SR including at least one of the authentication vector or the first proof parameters.

14. The method of claim 11, further comprising:
receiving, by the GW, through the secure communication tunnel a service request (SR) for the following NF service from the NF service consumer, the SR including an authentication vector;
following receipt of the SR for the following NF service and prior to providing the following NF service to the NF service consumer, validating, by the GW, the authentication vector; and
providing, by the NF service producer, the following NF service to the NF service consumer using the secure communication tunnel.

15. The method of claim 13, wherein, prior to sending the SR for the following NF service, the NF service consumer generates the authentication vector based at least in part on at least one of a second proof, the first proof parameters, or a third proof.

16. A system comprising a network function (NF) service producer and a gateway (GW) of a network, wherein:
the GW is configured to:
receive, from an NF service consumer, a service request for at least one NF service;
generate a temporary identifier (ID) of the NF service consumer, a temporary ID of a NF service producer, and a first proof for use by the NF service producer to authenticate the NF service consumer; and
send an access request to the NF service producer, the access request including at least one of: the first proof, the temporary ID of the NF service consumer, or the temporary ID of the NF service producer; and
the NF service producer is configured to:
receive the access request;
validate the first proof; and
send a response to the access request to the GW, the response confirming results of said validating the first proof.

17. The system of claim 16, wherein the access request further includes at least one of: one or more first proof parameters, NF service requirements, and a certificate of the GW.

18. The system of claim 17, wherein said validation of the first proof is based, at least in part, on the one or more first proof parameters, a permanent ID of the NF service producer, or a procedure negotiated between the GW and the NF service producer.

19. The system of claim 16, wherein the NF service producer is further configured to:
authorize the at least one NF service to be provided to the NF service consumer; and
generate a second proof for the NF service consumer to authenticate the NF service producer and to access the NF service producer.

20. A non-transitory computer readable storage medium, comprising instructions that, when executed by one or more processors, cause the one or more processors to perform operations comprising:
receiving, from a network function (NF) service consumer, a service request for at least one NF service;
generating a temporary ID of the NF service consumer, a temporary ID of an NF service producer, and a first proof for use by the NF service producer to authenticate the NF service consumer; and
sending an access request to the NF service producer, the access request including at least one of: the first proof, the temporary ID of the NF service consumer, or the temporary ID of the NF service producer;
receiving the access request,
validating the first proof; and
sending a response to the access request to a gateway (GW), the response confirming results of said validating.
